(19) United States
(12) Patent Application Publication
(10) Pub. No.: US 2008/0223231 A1
(43) Pub. Date: Sep. 18, 2008

(54) WORK-STATION PRESS

(75) Inventor: Wolfgang Krahl, Laupheim (DE)

Correspondence Address: K.F. ROSS P.C., 5683 RIVERDALE AVENUE, SUITE 203 BOX 900, BRONX, NY, 10471-0900, US

(73) Assignee: Uhlmann Pac-Systeme GmbH & Co. KG

(21) Appl. No.: 12/048,677

(22) Filed: Mar. 14, 2008

(30) Foreign Application Priority Data
Mar. 14, 2007 (DE) 102007012956.6

(51) Int. Cl. B30B 5/00

(52) U.S. Cl. 100/264

(57) ABSTRACT

A press has a support frame, a fixed traverse, a movable traverse vertically spaced from the fixed traverse, and a guide frame extending from the fixed traverse toward the movable traverse and supporting the movable traverse for vertical movement toward and away from the one traverse. A rigid brace frame has an arm vertically fixed to one of the traverses and another arm. The other of the traverses is between the other arm and the one traverse. One of the frames is fixed to the support frame, and a vertically expansible actuator between the other arm and the other traverse so that the actuator can vertically shift the other traverse toward the one traverse.

### FIELD OF THE INVENTION

The present invention relates to a work station. More particularly this invention concerns a press such as used for shaping, stamping, thermoshaping, sealing, or embossing.

### BACKGROUND OF THE INVENTION

A typical such press has a lower traverse and a upper traverse, wherein in the support frame at least the lower traverse or the upper traverse is displaceable relative to the other.

Work stations of this type for use in thermoforming machines are described, for example, in U.S. Pat. No. 7,331,281, German 4,303,017, and German 102 20 963. They are available in four-column designs that require a great deal of installation space, because the tools must be pulled out from between the columns to replace them. Less installation space is required for work stations with tie rods, however during tool replacement the rods must be withdrawn because they access to the tool. In addition, these systems do not guarantee even surface pressure across the entire surface to be processed since the frequently great pressures involved actually bend the supports so that the platens or traverses go out of parallel.

### OBJECTS OF THE INVENTION

It is therefore an object of the present invention to provide an improved press or work station.

Another object is the provision of such an improved press or work station that overcomes the above-given disadvantages, in particular that requires minimal space and gives good access to the workpiece it is acting on and tools it is using.

### SUMMARY OF THE INVENTION

A press has according to the invention a support frame, a fixed traverse, a movable traverse vertically spaced from the fixed traverse, a guide frame extending from the fixed traverse toward the movable traverse and supporting the movable traverse for vertical movement toward and away from the one traverse, a rigid brace frame having an arm vertically fixed to one of the traverses and another arm. The other of the traverses are between the other arm and the one traverse, one of the frames are fixed to the support frame, and a vertically expansible actuator between the other arm and the other traverse so that the actuator can vertically shift the other traverse toward the one traverse.

In other words, the lower traverse or upper traverse is provided with a guide frame performing a guiding function and the other traverse is provided with a brace frame performing a force transmitting function.

This design offers the significant advantage that the components subject to heavy load in the work station are separated from those that are required for precise guidance. The application the force to the tools in the work station thus does not significantly influence guidance for displacement of the tools provided on the lower traverse and the upper traverse. Within the scope of the invention it is preferred to mount the guide frame fixedly on the support frame and connect it via a first pivot to the brace frame. Due to the fixed association of the guide frame with the support frame, the rigid retention thereof in the reference system defined by the support frame is guaranteed, and position changes of the brace frame relative to the guide frame can be compensated for via the pivot, for example if the brace frame deforms elastically due to the force that is applied. It is advantageous if the lower traverse forms part of the fixed guide frame because this results in a compact design with low space requirements.

Furthermore according to the invention the upper traverse is provided with the brace frame and is connected thereto via a second pivot. This second pivot, like the first pivot, serves to keep deflections or deformations in general of the brace frame away from the upper traverse.

In order to displace the upper traverse, a toggle lever and/or a crank are provided, because in this way these driving elements can easily move the upper traverse. It is also conceivable that the crank serves for driving the toggle lever, in which case the drive shaft for the crank is provided between the upper and lower dead centers of a eccentric drive for drive purposes.

If the drive shaft is provided with a first movement sensor, it is possible during displacement of the upper traverse in the work station to perform a correction in order to guarantee precise displacement of the upper traverse with the tool.

Furthermore, it is possible that the upper traverse is provided with a second movement sensor in order to achieve or verify an exact amount of displacement of the upper traverse and optionally correct the movement by means of a feedback system.

A further special advantage of the invention is that the brace frame has a C-shape, so that accessibility of the tools is facilitated because it is possible for the operator to access them from the open side of the “C”.

Furthermore, according to the invention in the force transmitting chain of the brace frame there is a prestressed spring that guarantees a defined force in a sufficiently large tolerance range, so that deflection of the brace frame does not have any critical impact on the process force effective in the work station.

In order to be able to verify the level of force applied to the workpiece via the tools, a force sensor is disposed in the force-transmitting chain of the brace frame.

### BRIEF DESCRIPTION OF THE DRAWING

The above and other objects, features, and advantages will become more readily apparent from the following description, reference being made to the accompanying drawing in which:

FIG. 1a is a perspective view of a work station according to the invention;

FIG. 1b is a side schematic view of the parts of the work station that are essential for the invention;

FIG. 2 is a section through the of the brace frame of the work station;

FIG. 3 is a section through the guide frame of the work station;

FIG. 4 is a schematic diagram of the work station in its idle position when it is not actively applying force; and

FIG. 5 is a schematic diagram of the deformed work station when applying force.

### SPECIFIC DESCRIPTION

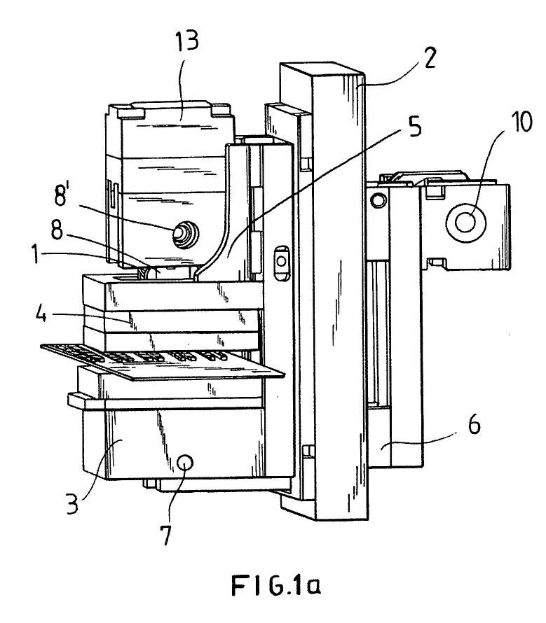

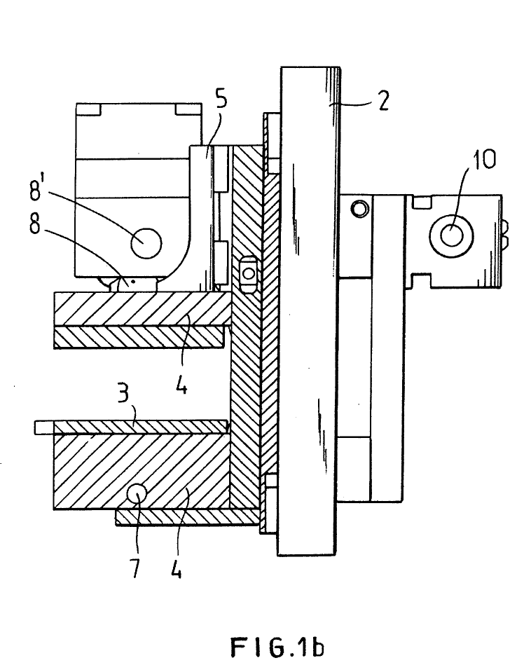

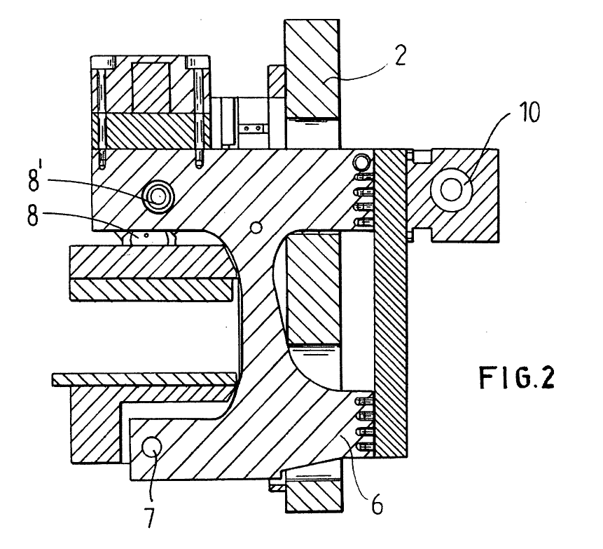

As seen in FIGS. 1-3 a work station 1 that can be used for forming, sealing station, embossing, or stamping in a thermoforming machine has a support frame 2 carrying a lower traverse 3 and a upper traverse 4. In the illustrated embodiment, the upper traverse 4 can move vertically on the support frame 2 and the lower traverse 3 is vertically fixed thereon, although it would also be possible to kinematically reverse this and make the lower traverse 3 movable and the upper traverse 4 movable since all that is necessary for operation of the work station 1 is relative movability of the upper traverse 4 and lower traverse 3.

According to the invention the lower traverse 3 has a guide frame 5 and the upper traverse 4 has a C-shaped force-transmitting brace frame 6. The guide frame 5 is fixed on the support frame 2 and is connected to the brace frame 6 by a first pivot 7. The upper traverse 4 is vertically connected with the brace frame 6 by a second pivot 8. The lower traverse 3 thus forms part of the fixed guide frame 5. In the illustrated embodiment the upper traverse 4 is moved by toggle levers 16 driven by a crank 9 whose drive shaft 10 displaces a tool 17 provided on the upper traverse 4 between the upper and lower dead centers relative to a tool 18 on the lower traverse 3. These levers 16 extend between a pivot 8′ on the brace frame 6 for the upper end of the upper lever 16 and the pivot 8 on the upper traverse 4 for the lower lever 16. The drive shaft 10 is part of an eccentric and has a first movement sensor 11, and the upper traverse 4 has a second movement sensor 12. A prestressed spring 13 and a force sensor 14 are mounted in the force-transmitting chain of the brace frame 6.

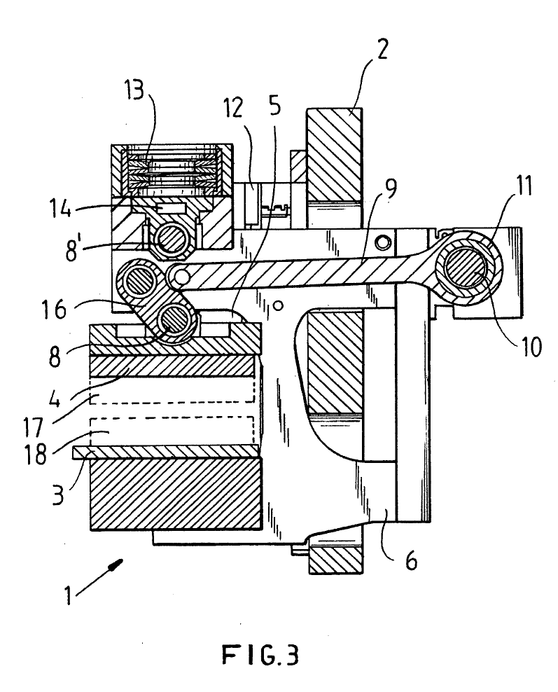

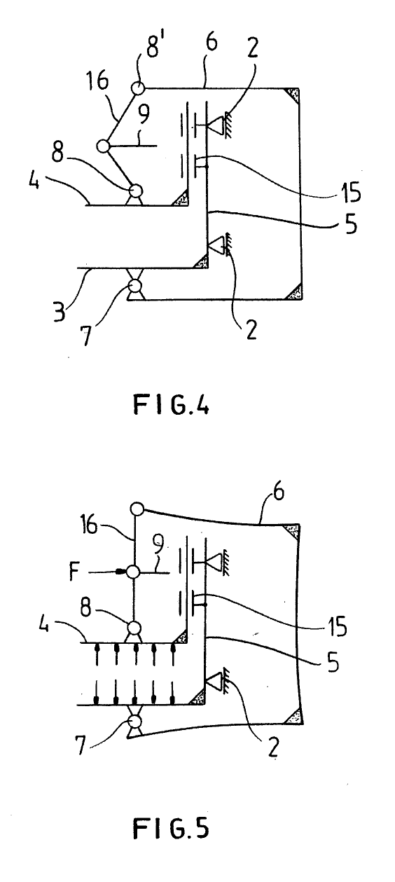

As shown in FIGS. 4 and 5, this machine 1 operates as follows:

As can be seen in FIG. 4, pressing force is wholly transmitted between the lower traverse 3 and upper traverse 4 by the brace frame 6. The upper traverse 4 is connected via linear guides 15 to the guide frame 5 that in turn is fixed on the support frame 2 and is also vertically fixed by the pivot 7 to the lower traverse 3. As a result of the vertical force that is applied, the brace frame 6 deforms as shown in FIG. 5, with its upper arm bending up, its lower arm bending down, and its vertical connecting bight bowing horizontally convex toward the traverses 3 and 4. This elastic deformation is not transmitted to the lower and upper traverses 3 and 4 because they are supported on the frame 6 by the lower and upper pivots 7 and 8. Thus they can remain parallel for proper press action.

With this system the two traverses or platens 3 and 4 and their tools 17 and 18 can remain perfectly parallel even if so much force is applied that the C-shaped brace frame distorts elastically. Nonetheless the entire front of the press, facing to the left in the figures, is open for easy servicing of the tools 17 and 18 and any workpiece therebetween.

I claim:

1. A press comprising:
a support frame;
a fixed traverse;
a movable traverse vertically spaced from the fixed traverse;
a guide frame extending from the fixed traverse toward the movable traverse and supporting the movable traverse for vertical movement toward and away from the one traverse;
a rigid brace frame having an arm vertically fixed to one of the traverses and another arm, the other of the traverses being between the other arm and the one traverse, one of the frames being fixed to the support frame; and
a vertically expansible actuator between the other arm and the other traverse, whereby the actuator can vertically shift the other traverse toward the one traverse.

2. The press defined in claim 1 further comprising:
a pivot between the actuator and the other traverse; and
another pivot between the one traverse and the rigid brace frame.

3. The press defined in claim 2 wherein the pivots define substantially parallel and horizontal axes.

4. The press defined in claim 3 wherein the brace frame is C-shaped and lies in a vertical plane generally perpendicular to the axes.

5. The press defined in claim 4 wherein the brace frame has a vertical bight part extending between and unitary with the arms.

6. The press defined in claim 1 wherein the guide frame is fixed on the support frame.

7. The press defined in claim 1 wherein the actuator includes a pair of pivoted-together toggle levers.

8. The press defined in claim 7 wherein the actuator includes a crank connected to a pivot between the toggle levers.

9. The press defined in claim 8 wherein the actuator includes an eccentric connected to the crank.

10. The press defined in claim 1, further comprising
a spring braced between the other traverse and the other arm.

11. The press defined in claim 10 wherein the spring is braced between the actuator and the other arm.

12. The press defined in claim 1 further comprising a movement detector associated with the other traverse.

13. The press defined in claim 1 further comprising a movement detector associated with the actuator.

14. The press defined in claim 1 further comprising a force detector associated with the actuator.
